(19) United States
(12) Patent Application Publication
(10) Pub. No.: US 2007/0054618 A1
(43) Pub. Date: Mar. 8, 2007

(54) System and method for wireless access point with integrated emergency devices

(76) Inventors: Jonathan F. Lewis, Pflugerville, TX (US); Andrew T. Sultenfuss, Leander, TX (US)

Correspondence Address: HAMILTON & TERRILE, LLP, P.O. BOX 203518, AUSTIN, TX, 78720, US

(21) Appl. No.: 11/222,311

(22) Filed: Sep. 8, 2005

(51) Int. Cl. H04B 7/00

(52) U.S. Cl. 455/41.2

(57) ABSTRACT

Wireless access points integrate building functions for improved building safety and reduced building wiring. A battery associated with a wireless access point is charged using power from a Power over Ethernet cable. The battery supports functions of the wireless access point and one or more building devices in the event of a power failure, the building devices communicating information through the wireless access point. For instance, emergency lighting and textual lamps are illuminated with the battery in the event of a power outage. As another example, fire sensors, fire alarms and intercoms provide emergency workers information and voice communication regarding the area within the proximity of a wireless access point to aid in rescue or fire fighting efforts.

### BACKGROUND OF THE INVENTION

1. Field of the Invention

The present invention relates in general to the field of information handling system networking, and more particularly to a system and method for a wireless access point having integrated emergency devices.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems often interface with each other through networks. For instance, businesses often interface employee information handling systems of a building site through a local area network (LAN). A typical business building site has Ethernet cables strung between the offices where information handling systems are located and one or more server locations where a server information handling system coordinates network communications and provides access to wide area networks (WAN) and the Internet. As businesses grow and move and as buildings age, a considerable amount of networking cabling is typically distributed about the building. In addition to networking cables, businesses also typically distribute power cables, communication cables and various emergency equipment, such as battery-powered emergency lights. The distribution of power, communications and emergency equipment is generally governed by local building codes. Compliance with such legal requirements adds to the expense of setting up and maintaining an office environment.

One solution to the difficulty of stringing Ethernet cabling across a business site is to instead use wireless networking, such as in compliance with the IEEE 802.11 (b) and (g) standards. Wireless access points (WAP) are distributed through the building site with each WAP typically providing networking coverage to plural information handling systems and peripherals. The WAPs are typically interfaced with a server information handling system using Ethernet cabling, however, the amount of cabling used for distributed WAPs is generally considerably less than that used for wiring each system and peripheral with cables. In addition, the new Power over Ethernet (PoE) standard has reduced the complexity of installing WAPs by providing power to operate the WAPs through the Ethernet cable. Wireless networking improves employee efficiency by freeing information handling system users from fixed locations for interfacing with a network. Wireless networking also allows for greater flexibility in the use of building space by allowing information handling systems and peripherals to remain interfaced with the same networking configuration throughout the coverage of the WAPs deployed in the building space. Although distributed WAPs decrease the cabling needed in a typical business space environment, other types of cabling remains for supporting various functions, such as emergency lighting, alarms, speakers and microphones.

### SUMMARY OF THE INVENTION

Therefore a need has arisen for a system and method which integrates building functions distributed across a building space into wireless access points distributed across the building space.

In accordance with the present invention, a system and method are provided which substantially reduce the disadvantages and problems associated with previous methods and systems for distributing building functions and networking WAPs across a business space. Distributed wireless access points receive power from networking cables to charge a battery. The battery powers building devices that perform building functions, such as emergency lighting. The wireless access point provides a communication channel for the building devices to communicate with information handling systems internal and external to the building space.

More specifically, a wireless access point connects at a network interface with an Ethernet cable having Power over Ethernet functionality. A power supply receives power from the network interface and provides the power to a wireless gateway for supporting wireless networking and to a battery. The battery provides power to a building device power supply which powers a variety of building devices internal or external to the wireless access point, such as an emergency lamp, a textual warning lamp, a fire alarm pull, a heat sensor, a smoke detector, or an intercom. The wireless gateway has a building device interface that communicates information between the building devices and the wireless network or Ethernet cable. A Voice over Internet Protocol module interfaces an intercom with the wireless gateway to support voice communication between the location of the wireless access point and a distal network location.

The present invention provides a number of important technical advantages. One example of an important technical advantage is that the integration of building devices with wireless access points reduces the wiring needed within a building space. The building devices are powered through the wireless access point Ethernet cable and use the wireless access point as a communication channel to communicate information relating to building functions. Advantageously, the building devices may use the wireless access point to communicate information external to the building, such as smoke and heat sensor readings that are communicated to emergency worker sensors located on emergency vehicles, allowing more rapid and accurate analysis of conditions within the building space.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a building area having building functions supported by wireless access points; and

FIG. 2 shows a block diagram of a wireless access point having integrated building device support.

### DETAILED DESCRIPTION

Wireless access points that support communication of information handling systems across a wireless network also integrate support for building devices disposed through a building area proximate wireless access points. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

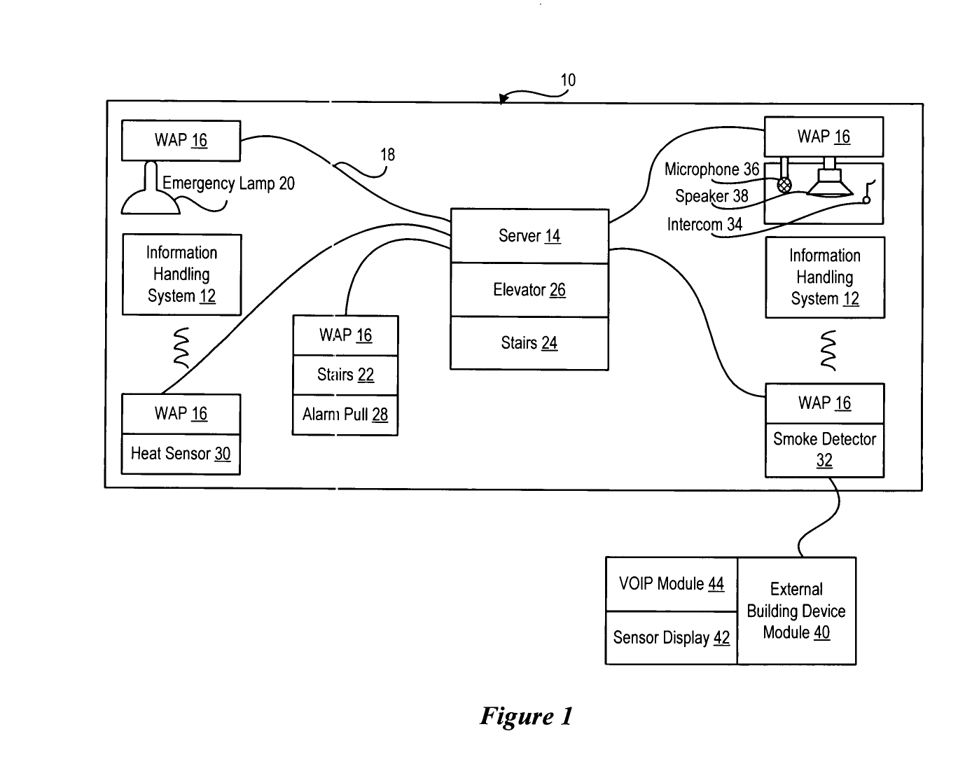

Referring now to FIG. 1, a block diagram depicts a building area having building functions supported by wireless access points. Building area 10 provides room to deploy plural information handling systems 12 which communicate through a local area network having a server information handling system 14 and plural wireless access points 16. Server information handling system 14 communicates with wireless access points 16 through Ethernet cables 18 that also provide power to wireless access points 16 with Power over Ethernet technology. Information handling systems 12 communicate with server 14 and each other using wireless signals sent through wireless access points 16.

As is depicted by FIG. 1, wireless access points 16 are disposed throughout building area 10 to facilitate network availability and also to provide a variety of building functions by supporting a variety of building devices. One type of building device is a lamp for emergency or safety lighting that is powered with a battery charged from power received through Ethernet cable 18, such as emergency lamp 20 or textual warning lamp 22. Emergency lamp 20 provides illumination in the event of primary lighting or power failure. Textual warning lamp 22 provides illumination of a textual message, such as the identification of the location of stairs 24, elevator 26 or safety equipment like a fire alarm or fire extinguisher. Other types of building devices not only use wireless access points 16 for a supply of power but also as a communication channel. For instance, an alarm pull 28 communicates an alarm indication through wireless access point 16 either as an Ethernet signal sent to server 14 or as a wireless signal sent to another information handling system. As another example, fire sensors, such as heat sensor 30 or smoke detector 32, communicate fire indications through wireless access point 16, and an intercom 34 communicates voice information by using a microphone 36 and a speaker 38. Communication through a wireless access point 16 advantageously makes the information available to an external building device module 40 so that emergency workers can track the information, such as with an external sensor display 42 that interfaces with the fire sensors or an external VoIP module 44 that use Voice over Internet Protocol to interface with intercom 34.

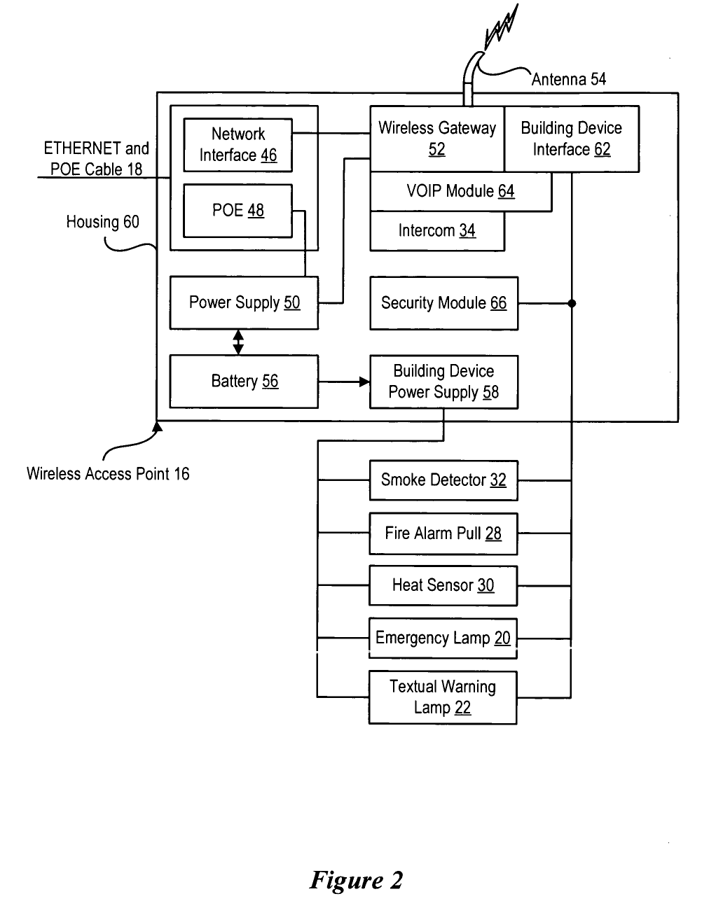

Referring now to FIG. 2, a block diagram depicts a wireless access point 16 having integrated building device support. Ethernet cable 18 connects to a network interface card 46 having a Power over Ethernet interface 48. A power supply 50 interfaces with Power over Ethernet interface 48 and supplies power to a wireless gateway 52. Wireless gateway 52 interfaces wireless signals from antenna 54 with wire line signals from cable 18 in a conventional manner. Power supply 50 also interfaces with and charges a battery 56. Battery 56 provides power to a building device power supply 58 which powers individual building devices, such as emergency lamp 20 textual warning lamp 22, fire alarm pull 28, heat sensor 30 and smoke detector 32. The building devices may be integrated in the same housing 60 as wireless access point 16 or attached as separate and/or interchangeable devices. A building device interface 62 communicates information between the building devices and wireless gateway 52 for communication through cable 18 or wireless signals from antenna 54. A VoIP module 64 interfaces intercom 34 with gateway 52 to support voice communication as VoIP formatted information sent through cable 18 or wireless signals through antenna 54.

In alternative embodiments, wireless access points deployed in a building space with standardized external peripheral device interfaces, such as a power jack and USB interface, offer tremendous flexibility for network and non-network device architectures in the building space. As one example, video cameras provide hallway and site monitoring for security using standardized network protocols that communicate through the wireless access point. As another example, enhanced security beyond wireless security measures is provided, such as with SHA-1, DES/3DES/TPM/Biometric or similar technologies, to provide restricted access with co-location of a wireless access point, hardened security or alarm testing. A physical security reader can interface with a wireless access point to include a wireless reader, such as DHS FIPS201, to have reduced wiring and cost with, for instance, the sensor reader extended from the wireless access point by an additional cable. Security is further enhanced by interfacing intrusion detection, fire, carbon monoxide or personnel devices as desired. For example, a security module 66 monitors access through wireless gateway 52 and network interface 46 to confirm that communications with a peripheral device are authorized. Security module 66 restricts access to peripheral devices with password or other protection so that unauthorized actions will not occur, such as activation of a fire alarm or monitoring of video or audio signals by unauthorized parties communicating through wireless gateway 52 or network interface 46. As some examples, access is selectively restricted by badge, network, visual, biometric or proximity access. A firewall associated with security module 66 manages communication of data and security information over either the wireless or wired network interface. The powering of such devices with PoE from a server having a power backup will help maintain continuity of sensitive equipment even during power interruptions.

Although the present invention has been described in detail, it should be understood that various changes, substitutions and alterations can be made hereto without departing from the spirit and scope of the invention as defined by the appended claims.

What is claimed is:

1. A wireless access point comprising:
a wireless gateway operable to interface with plural information handling systems to send and receive information using wireless signals;
a network interface in communication with the wireless gateway, the network interface operable to connect to an Ethernet cable to send and receive information using Ethernet signals;
a power supply associated with the network interface and operable to receive power over the Ethernet cable to power the wireless gateway;
a battery interfaced with the power supply, the power supply operable to charge the battery with the power received over the Ethernet cable; and
a building device power supply interfaced with the battery and operable to provide power to one or more building devices.

2. The wireless access point of claim 1 further comprising an emergency lamp interfaced with the building device power supply, the emergency lamp operable to illuminate the building powered by the battery in the event of a building power failure.

3. The wireless access point of claim 1 further comprising a textual lamp operable to identify a building location, the textual lamp interfaced with the building device power supply and powered by the battery.

4. The wireless access point of claim 1 further comprising a building device interface in communication with the wireless gateway and operable to communicate with a building device to send information between the building device and the wireless gateway.

5. The wireless access point of claim 4 wherein the building device comprises a smoke detector, the smoke detector operable to receive power from the battery and to communicate smoke detection results through the wireless gateway to an external building device module.

6. The wireless access point of claim 4 wherein the building device comprises a heat sensor, the heat sensor operable to receive power from the battery and to communicate heat detection results through the wireless gateway to an external building device module.

7. The wireless access point of claim 4 wherein the building device comprises a fire alarm pull, the fire alarm pull operable to receive power from the battery and to communicate a fire alarm through the wireless gateway to an external building device module.

8. The wireless access point of claim 1 further comprising:
a microphone;
a speaker; and
a VoIP module interfaced with the microphone, speaker and wireless gateway, the VoIP module communicate voice information through the wireless gateway between the speaker, microphone and an external building device module.

9. A method for deploying a building device in a building space, the method comprising:
deploying a wireless access point in the building space;
powering the wireless access point through an Ethernet cable;
storing power provided from the Ethernet cable with a battery associated with the wireless access point;
deploying the building device proximate the wireless access point; and
powering the building device with the battery.

10. The method of claim 9 wherein the building device comprises an emergency lamp, the method further comprising:
detecting a power failure in the building space; and
illuminating the emergency lamp with the battery.

11. The method of claim 9 wherein the building device comprises a textual lamp.

12. The method of claim 9 wherein the building device comprises a fire alarm pull, the method further comprising:
detecting a fire alarm indication at the fire alarm pull; and
communicating the fire alarm to a network through the wireless access point.

13. The method of claim 9 wherein the building device comprises a smoke detector, the method further comprising:
detecting smoke indications with the smoke detector; and
communicating the smoke indications to a network through the wireless access point.

14. The method of claim 9 wherein the building device comprises a heat sensor, the method further comprising:
detecting heat indications with the heat detector; and
communicating the heat indications to a network through the wireless access point.

15. The method of claim 9 wherein the building device comprises an intercom, the method further comprising:
supporting voice communications with the intercom; and
communicating the voice communications to a network as VoIP information passed through the wireless access point.

16. A system for supporting network communications and building functions in a building space, the system comprising:
a server information handling system operable to support networking of plural information handling systems, the server information handling system having plural networking ports operable to connect with networking cables to provide networking signals and power to the cables;
plural wireless access points deployed in the building space, each wireless access point operable to communicate with information handling systems using wireless signals;
plural networking cables, each networking cable connecting the server information handling system to a wireless access point;
a power supply associated with each wireless access point and operable to receive power from the networking cable to power the wireless access point; and
a battery interfaced with the power supply, the battery operable to receive a charge from the power supply and to supply power to a building device that performs the building function.

17. The system of claim 16 further comprising a building device interface associated with each wireless access point and operable to communicate with the building device, the wireless access point further operable to communicate information between the building device and the network.

18. The system of claim 17 wherein the building device comprises an intercom and the information comprises voice information.

19. The system of claim 17 wherein the building device comprises a sensor operable to sense fire conditions.

20. The system of claim 16 wherein the building device comprises a lamp.
